(19) United States
(12) Patent Application Publication
(10) Pub. No.: US 2023/0068290 A1
(43) Pub. Date: Mar. 2, 2023

(54) IMPLEMENTATION METHOD AND SYSTEM OF RISC_V VECTOR INSTRUCTION SET VSETVLI INSTRUCTION

(71) Applicant: Guangdong StarFive Technology Co., Ltd., Foshan (CN)

(72) Inventors: Changlin Li, Shanghai (CN); Chi Zhang, Shanghai (CN)

(73) Assignee: Guangdong StarFive Technology Co., Ltd., Foshan (CN)

(21) Appl. No.: 17/981,365

(22) Filed: Nov. 4, 2022

Related U.S. Application Data
(63) Continuation of application No. PCT/CN2021/129454, filed on Nov. 9, 2021.

(30) Foreign Application Priority Data
Mar. 22, 2021 (CN) 202110300024.9

(51) Int. Cl. G06F 9/30; G06F 9/38

(52) U.S. Cl. CPC G06F 9/30036; G06F 9/3855

(57) ABSTRACT

The invention relates to the technical field of CPUs, in particular to a method and system for implementing a risc_v vector instruction set vsetvli instruction. it allocates vectag[n:0] information in the rename module when the CPU executes out of order, and determines whether the instruction is vsetvli. If the instruction is vsetvli, vectag+1 is added. If it is a non-vsetvli instruction, the vectag remains unchanged; it is sent to the execution unit, and the vsetvli instruction is distributed to the csr module; and the corresponding other vector instructions are distributed to the vpu module. The non-vsetvli{i} Vector instruction execution efficiency of the present invention is high. Data is selected by mask, which reduces power consumption, reduces execution cycle and latency, and has strong market application prospects.

### TECHNICAL FIELD

The invention relates to the technical field of CPUs, in particular to a method and system for implementing a risv_v vector instruction set vsetli instruction.

### BACKGROUND TECHNOLOGY

The isc_v instruction set has only recently published the complete instruction set, but there is basically no implementation method available for reference at present. In order to achieve simplicity, the simplest way is that the vsetli instruction needs to be refreshed upon graduation, and the execution unit, regardless of the unactive element part, is sent to the execution unit for execution, resulting in an increase in the execution cycle.

The existing vsetli instructions need to be refreshed when they graduate, resulting in low efficiency of CPU execution. The unactive element part of the Vector instruction is also executed in the execution unit, and finally the data is selected by the way of mask. In fact, the data of mask does not need to enter the execution unit, which leads to power consumption and increases the execution cycle of the instruction.

### SUMMARY OF THE INVENTION

In view of the deficiency of the prior art, the invention discloses a method and a system for realizing risv_v vector instruction set vsetli instruction, which is used for solving the existing problems.

The invention is realized through the following technical proposal:

First, the invention discloses a method for realizing risv_v vector instruction set vsetli instruction, which comprises the following steps:

When the S1CPU is executed out of order, the vectag [n:0] information is allocated in the rename module to determine whether the instruction is vsetli.

S2 if the instruction is vsetli, then vectag+1, if it is not vsetli instruction, then vectag remains unchanged.

S3 is transmitted to the execution unit, vsetli instructions are distributed to the csr module, and other vector instructions are distributed to the vpu module.

When S4 determines that the instruction vectag is consistent with the vectag broadcast by ROB, the instruction is transmitted from reserver station to the execution unit.

The execution of S5 instruction is completed, in the ROB module, graduate in order, and update the register vectag when graduation, the execution ends.

Further, in the method, each cycle emits 0-5 instructions.

Further, in the method, if the vsetli instruction is accepted, the cycle only transmits vsetli, each cycle allocates one vectag, and other instructions are not transmitted until the next cycle.

Further, in the method, the unactive is transmitted to the execution unit, 2 cm cycle completion is performed, the unactive is not transmitted to the execution unit, and n cycle completion is executed.

Further, in the method, the instruction vectag in the vpu module reserve station needs to be compared with the register vectag, and only if the instruction is consistent can the instruction be transmitted to the execution unit.

Further, in the method, the vectag [Nvpu 0] is allocated in the rename as a condition for the vpu instruction to be transmitted to the execution unit without refreshing the pipeline when the vsetli instruction is executed.

In the second aspect, the invention discloses a system for realizing risv_v vector instruction set vsetli instruction. The system is used for executing the realization method of risv_v vector instruction set vsetli instruction described in the first aspect, which comprises rename module, dispatch module, vpu module and ROB module.

The beneficial effects of the invention are:

The non-vsetl {i} Vector instruction of the invention only needs to be executed according to the youngest instruction in the older vsetl {i} before entering the execution unit, which is much higher than the current refresh pipeline efficiency.

The Vector instruction of the invention also executes the unactive element part in the execution unit, and finally selects the data by the way of mask, which can reduce the power consumption, at the same time reduce the execution cycle and reduce the latency.

### DESCRIPTION OF DRAWINGS

In order to more clearly illustrate the technical scheme in the embodiment of the invention or the prior art, the following will briefly introduce the drawings that need to be used in the embodiment or the prior art description, obviously, the drawings described below are only some embodiments of the invention, and for ordinary technicians in the art, other drawings can be obtained according to these drawings without creative work.

FIG. 1 is a principle step diagram of a method of implementing vsetli instructions in risv_v vector instruction set.

FIG. 2 is a basic block diagram of the out-of-order CPU of the embodiment of the present invention.

FIG. 3 is a unactive transmission comparison block diagram of an embodiment of the present invention.

### DETAILED DESCRIPTION

In order to make the purpose, technical scheme and advantages of the embodiment of the invention more clear, the technical scheme in the embodiment of the invention will be described clearly and completely in combination with the drawings in the embodiment of the invention. Obviously, the described embodiments are some embodiments of the invention, not all embodiments. Based on the embodiments of the invention, all other embodiments obtained by ordinary technicians in the field without creative work fall within the scope of the protection of the invention.

### Embodiment 1

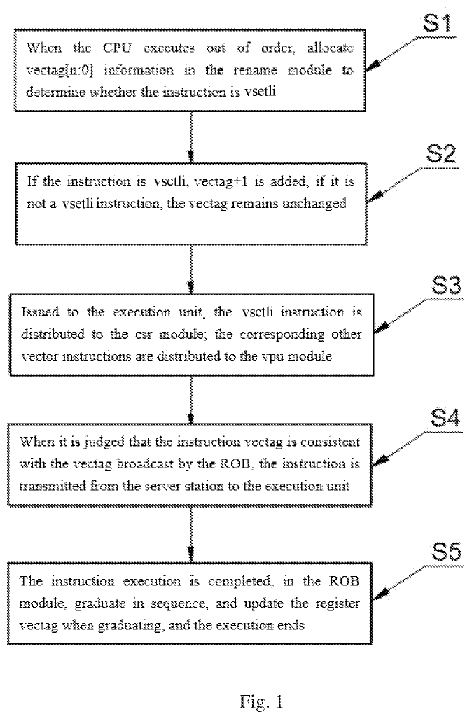

The present embodiment discloses a method for implementing risv_v vector instruction set vsetli instructions as shown in FIG. 1, which includes the following steps:

When the S1CPU is executed out of order, the vectag[n:0] information is allocated in the rename module to determine whether the instruction is vsetli.

S2 if the instruction is vsetli, then vectag+1, if it is not vsetli instruction, then vectag remains unchanged.

S3 is transmitted to the execution unit, vsetli instructions are distributed to the csr module, and other vector instructions are distributed to the vpu module.

When S4 determines that the instruction vectag is consistent with the vectag broadcast by ROB, the instruction is transmitted from reserver station to the execution unit.

The execution of S5 instruction is completed, in the ROB module, graduate in order, and update the register vectag when graduation, the execution ends.

In the present embodiment, each cycle emits 0-5 instructions. If the vsetli instruction is accepted, the cycle only transmits vsetli, each cycle allocates one vectag, and the other instructions are not sent until the next cycle.

In the present embodiment, the unactive is transmitted to the execution unit, the execution of 2n cycle is completed, the unactive is not transmitted to the execution unit, and the execution of n cycle is completed.

In the present embodiment, the instruction vectag in the vpu module reserve station needs to be compared with the register vectag, and only if the instruction is consistent can the instruction be transmitted to the execution unit.

In the present embodiment, the vectag [n:0] is allocated in the rename as a condition for the vpu instruction to be transmitted to the execution unit without refreshing the pipeline when the vsetli instruction is executed.

The vsetli instruction of the present embodiment does not need to refresh the pipeline when graduating, and the unactive element part does not need to be transmitted to the execution unit for execution, which can reduce power consumption and execution cycle.

### Embodiment 2

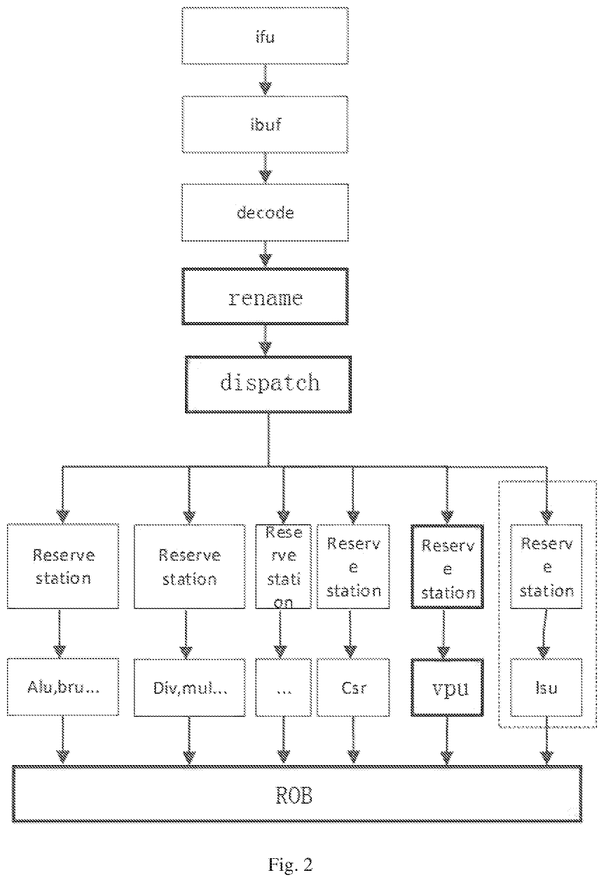

The embodiment refers to the out-of-order CPU, and its basic frame is shown in FIG. 2. The embodiment discloses a system for realizing risv_v vector instruction set vsetli instructions, which includes four modules: rename, dispatch, ROB and vpu.

The rename module of the present embodiment allocates a vectag [vsetli 0] information in the rename module, and if it is a vsetli, the vectag of the vectag+1, non-vsetli instruction remains unchanged, so that the instruction executed by the vpu unit can be transmitted to the execution unit only if the vectag of the instruction in the reserve station is consistent with the vectage broadcast by the csr.

The function of the dispatch module of the embodiment is to distribute the instruction to different datapath according to the type of instruction, corresponding to the vsetli instruction to the csr module, and to the other vector instruction to the vpu module. Each cycle can send five instructions. If the vsetli instruction is encountered, the cycle only launches the vsetli, and the other instructions wait until the next cycle, so each cycle only needs to allocate one vectag.

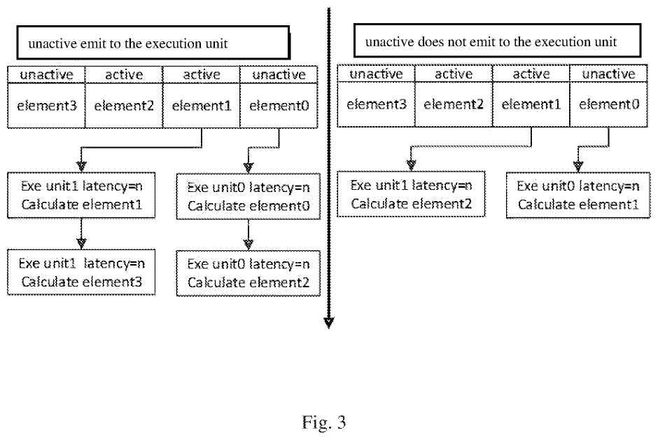

The vpu module of the present embodiment, the vector instruction datapath, an important condition for the instruction to be transmitted from the reserver station (reservation station) to the execution unit is that the instruction vectag of the entry is required to be consistent with the vectag broadcast by the ROB before it can be transmitted to the execution unit. As shown in FIG. 3, transmitting unactive to the execution unit requires 2n cycle to complete, and if the unactive is not transmitted to the execution unit, only n cycle is needed to complete. It can reduce latency and power consumption at the same time.

In the ROB module of the present embodiment, after each instruction is executed, it is necessary to graduate sequentially and update the register vectag at the same time.

Vectag allocates the update vectage register, and the timeline table of the conditions under which the vector instruction can be issued is as follows:

| | | | | | | | |
|---|---|---|---|---|---|---|---|
| Time | cycle1 | cycle2 | cycle3 | . . . | cycle_m | . . . | cycle_n |

| | | | | | | |
|---|---|---|---|---|---|---|
| Instruction | | vsetli | vec_instr0 | | | |
| 1 | | | | | | |
| Instruction | | | vec_instr1 | | | |
| 2 | | | | | | |
| Allocate | n | n + 1 | n + 1 | | | |
| the vectag | | | | | | |
| register | | | | | | |
| Graduation | | | | vsetli | | vec_instr0 |
| Instruction | | | | | | and |
| | | | | | | vec_instr1 |
| update | | | | Update | | |
| vectag | | | | | | |
| command | | | | | vec_instr0 | |
| can be | | | | | and | |
| issued | | | | | vec_instr1 | |
| | | | | | can emit | |

In summary, the non-vsetl {i} Vector instruction of the invention only needs to be executed according to the youngest instruction in the older vsetl {i} before entering the execution unit, which is much more efficient than the current refresh pipeline. Refreshing the pipeline needs to start with a fresh finger fetch, instead of just waiting in the reservation station until the youngest instruction in the older vsetl {i} has been executed.

The Vector instruction of the invention also executes the unactive element part in the execution unit, and finally selects the data by the way of mask, which can reduce the power consumption, at the same time reduce the execution cycle and reduce the latency.

The above embodiments are only used to illustrate the technical scheme of the invention, not to limit it; although the invention is described in detail with reference to the aforementioned embodiments, ordinary technicians in the field should understand that they can still modify the technical scheme recorded in the above-mentioned embodiments, or equivalent replacement of some of the technical features. These modifications or replacements do not deviate the essence of the corresponding technical scheme from the spirit and scope of the technical scheme of the embodiments of the present invention.

1-7. (canceled)

8. A method for realizing vsetvli instructions in a risc_v vector instruction set, the method comprising the following steps:
step S1: when a CPU is executed out of order, allocating vectag [n:0] information in a rename module to determine whether an instruction is a vsetvli instruction;
Step S2: if the instruction is vsetvli instruction, performing vectag+1, if the instruction is not vsetvli instructions, keeping vectag unchanged;
Step S3: distributing one or more vsetvli instructions to a csr module, and distributing one or more other vector instructions to a vpu module;
Step S4: when the vectag information of one or more instructions is determined to be consistent with a vectag broadcast by an ROB module, transmitting the one or more instructions from a reserve station to an execution unit; and
Step S5: completing execution of the one or more instructions, in the ROB module, graduating in order, and updating a register vectag when graduating.

9. The method according to claim 8, wherein each cycle emits 0-5 instructions.

10. The method according to claim 9, wherein, if the vsetvli instructions are accepted, a cycle only transmits the vsetvli instructions, each cycle allocates one vectag, and other instructions are not transmitted until the next cycle.

11. The method according to claim 8, wherein:
active element is transmitted to the execution unit, and
unactive element is not transmitted to the execution unit.

12. The method according to claim 8, further comprising: comparing the vectag information of an instruction in the reserve station with the register vectag, and only if the vectag information is consistent with the register vectag, transmitting the instruction comprising the vectag information to the execution unit.

13. The method according to claim 8, wherein vectag [n:0] is allocated in the rename module as a condition for other vector instructions to be transmitted to the execution unit, so that a pipeline is not refreshed when the vsetvli instructions are executed.

14. A system for realizing risc_v vector instruction set vsetvli instructions, the system comprising a rename module, a dispatch module, a vpu module and an ROB module; wherein the system is used for implementing risc_v vector instruction set vsetvli instructions by performing methods comprising steps of:
step S1: when a CPU is executed out of order, allocating vectag [n:0] information in a rename module to determine whether an instruction is a vsetvli instruction;
Step S2: if the instruction is vsetvli instruction, performing vectag+1, if the instruction is not vsetvli instructions, keeping vectag unchanged;
Step S3: distributing one or more vsetvli instructions to a csr module, and distributing one or more other vector instructions to a vpu module;
Step S4: when the vectag information of one or more instructions is determined to be consistent with a vectag broadcast by an ROB module, transmitting the one or more instructions from a reserve station to an execution unit; and
Step S5: completing execution of the one or more instructions, in the ROB module, graduating in order, and updating a register vectag when graduating.

15. The system according to claim 14, wherein each cycle emits 0-5 instructions.

16. The system according to claim 15, wherein, if the vsetvli instructions are accepted, a cycle only transmits the vsetvli instructions, each cycle allocates one vectag, and other instructions are not transmitted until the next cycle.

17. The system according to claim 14, wherein:
active element is transmitted to the execution unit, and
unactive element is not transmitted to the execution unit.

18. The system according to claim 14, wherein the steps further comprise:
comparing the vectag information of an instruction in the reserve station with the register vectag, and only if the vectag information is consistent with the register vectag, transmitting the instruction comprising the vectag information to the execution unit.

19. The system according to claim 14, wherein vectag [n:0] is allocated in the rename module as a condition for other vector instructions to be transmitted to the execution unit, so that a pipeline is not refreshed when the vsetvli instructions are executed.
